(19) United States
(12) Patent Application Publication
(10) Pub. No.: US 2023/0204528 A1
(43) Pub. Date: Jun. 29, 2023

(54) 1 MEV TO 3 MEV DEUTERON/PROTON CYCLOTRON FOR MATERIAL ANALYSIS

(71) Applicant: Best Theratronics Ltd., Kanata (CA)

(72) Inventors: Richard Johnson, Vancouver (CA); Karim Butalag, Brindisi (IT); Krishnan Suthanthiran, Lorton, VA (US)

(21) Appl. No.: 17/922,468

(22) PCT Filed: Apr. 26, 2021
(86) PCT No.: PCT/CA2021/050567

§ 371 Date: Oct. 31, 2022

Related U.S. Application Data
(60) Provisional application No. 63/017,546, filed on Apr. 29, 2020.

(51) Int. Cl. G01N 23/2257; G01N 23/203

(52) U.S. Cl. CPC G01N 23/2257; G01N 23/203

(57) ABSTRACT

Systems and methods related to the use of a proton/deuteron cyclotron for materials analysis and other industrial applications are provided. The methods, apparatuses and uses include positioning a target material for irradiation on a sample holder, focusing a hydrogen ion beam or a deuteron ion beam, such as a negative hydrogen ion or negative deuteron ion beam, from the cyclotron to the target material, irradiating the target material to induce a (d,*) or a (p,*) reaction thereby producing a radiation emission, and detecting the radiation emission using a detector, wherein the particle beam produced by the cyclotron has an energy in a range of from and including 1 MeV to 3 MeV and has a beam current in a range of from and including 5 pA to 100 nA.

### FIELD OF THE INVENTION

The present invention relates generally to cyclotrons and particularly to a compact proton/deuteron ion cyclotron having low energies in a range of from and including 1 MeV to 3 MeV to characterize the material atomic compositions of thin film samples by detecting the proton/deuteron reaction emissions for materials analysis in industrial applications.

### BACKGROUND

Cyclotrons have been known for many years. A cyclotron is one type of particle accelerators in which charged particles are accelerated through a substantially spiral path using the forces of electrical potential and magnetic fields. The first cyclotron was invented by Ernest O. Lawrence in 1929-1930 at the University of California, Berkeley, for which he was awarded the Nobel Prize in Physics in 1939.

A cyclotron accelerates a charged particle beam using a high frequency alternating voltage which is applied between two hollow “D”-shaped sheet metal electrodes called “dees” inside a vacuum chamber. The path of the accelerated particle is then bent by a magnetic field into a spiral path (due to the Lorentz force perpendicular to their direction of motion), which tends to cause the particle to be directed back across the gap. By alternately changing the polarity of the electrodes by means of a radio-frequency generating system, the particles are accelerated with each crossing of the gap, thereby increasing the radius of the spiral path of the accelerated particles. When the accelerated particles reach the rim of the chamber a small voltage on a metal plate deflects the beam and hits a target located at the exit point at the rim of the chamber.

For example, U.S. Pat. No. 5,139,731 to Hendry, incorporated herein by reference in its entirety, discloses a negative ion (H⁻) cyclotron caused by the gas stripping of the H− ions in the acceleration region. The system comprises a negative hydrogen ion cyclotron which defines a cyclotron volume, a negative hydrogen ion (H) source which defines a H ion source volume, and a vacuum system and a radio-frequency system for accelerating the ions within the cyclotron volume, the cyclotron volume having an acceleration plane in which the hydrogen ions are accelerated and deflected in a spiral path at an ion orbital frequency.

For example, U.S. Pat. No. 7,554,275 to Amaldi, incorporated herein by reference in its entirety, discloses a proton accelerator cyclotron. The cyclotron comprises at least one target located either internally or externally to the cyclotron, a medium energy beam transport magnetic channel, a radiofrequency linear accelerator, a high energy beam transport channel towards an area dedicated to the irradiation of tumors with proton beams, as well as a modular system for supplying radio frequency power capable of feeding, independently two or more accelerating modules of the linac. Further, Amaldi discloses an integrated computerized system that controls the complex of accelerators so as to carry out, either in alternation or simultaneously, both the production of radioisotopes—for medical, industrial and therapeutical purposes—and the therapeutical irradiation of, even deep seated tumors.

For example, Erdman et al., “Compact 9 MeV Deuteron Cyclotron with Pulsed Beam” Proc. XVI Cycl. Conf., (2001), p. 383-386, incorporated herein by reference in its entirety, discloses a compact commercial cyclotron to accelerate negative Deuteron ions (D−) having an energy ranging from 5.8 to 9 MeV. The authors propose to use the deuteron cyclotron to check on-line baggage for explosive materials and drugs. To enable a reasonable time to check each piece of luggage, it is very important to provide 2 nanosecond deuteron beam pulses with a repetition frequency of 1 MHz and average current of 25-50 micro-amperes.

Further, W. A. Lanford et al., “Nuclear Reaction Analysis For H, Li, Be, B, C, N, O and F With An RBS check”, Nuclear Instruments and Methods in Physics Research B 371 (2016) 211-215, incorporated herein by reference in its entirety, disclose the use of 1.3 MeV deuterons (D) to perform nuclear reaction analysis using the (d,*) reaction for Li, Be, B, C, N, O and F. The authors propose analyzing film composition by a self-consistent analysis of the light element nuclear reaction analysis data combined with a Rutherford Backscattering Energy (RBS) analysis for heavy elements.

For example, G. Demortier and F. Bodart “Complementarity of PIXE and PIGE For The Characterization of Gold Items of Antient Jewelry”, Journal of Radioanalytical Chemistry, Vol 69, No. 1-2 (1982) 239-257, incorporated herein by reference in its entirety, disclose the use of a 3 MeV proton accelerator to perform both Proton Induced X-ray Emission spectroscopy and Proton Induced Gamma ray Emission spectroscopy, to have a simultaneous composition of both low and mid Z elements in the samples.

For example, G. W. Grime et al. “Nuclear Microscopy of Inhomogeneous Thick Samples”, Nuclear Instrument and Methods in Physics Research B 54 (1991) 336-362, incorporated herein by reference in its entirety, disclose the use of a 3 MeV proton beam with a size of the order of the um in order to have a PIXE and RBS elemental map of the samples. A focusing system, such as a triplet of magnetic quadrupoles, has been used for this study.

For example, M. Budnar et al. “In-Air Pixe Set-Up For Automatic Analysis Of Historical Document Inks”, Nuclear Instrument and Methods in Physics Research B 219 (2004) 41-47, incorporated herein by reference in its entirety, disclose the use of PIXE in air in order to analyze samples not suitable for the vacuum (as old manuscript). This article also provides a discussion about the importance of having a reliable sample holding system, which is also able to allow the fast change of the samples.

Regarding the use of deuteron cyclotrons for radiochemical synthesis, for example, U.S. Pat. No. 3,981,769 to Winchell et al, incorporated herein by reference in its entirety, discloses a process for making Fluorine-18 comprising the steps of irradiating neon-20 gas molecules in an enclosed reaction zone with energetic deuteron particles to form Fluorine-18. The neon gas with deuterons is irradiated at an energy level ranging from 12-14 MeV for sixty (60) minutes at twenty-five (25) microamperes to produce about 400-500 mCi of Fluorine-18.

Additionally, for example, U.S. Pat. No. 7,888,891 B2 to Lida et al., incorporated herein by reference in its entirety, discloses a compact cyclotron system with deuteron beam energy ranging from about 3.5 MeV to 10 MeV that may potentially be used in generating radioactive drugs using the radioactive elements generated in the target cell, such as, for example, C¹⁵O, C¹⁵O₂ and ¹⁵O.

While negative hydrogen ions and deuteron cyclotrons have been used to produce radionuclides, very little is known about using negative hydrogen ions and deuteron cyclotrons for materials studies using low energy deuteron and proton beams. Accordingly, there is a need for a compact low energy deuteron cyclotron having a beam energy in a range of from and including 1 MeV to 3 MeV for materials studies.

Thus, apparatuses and methods of using a deuteron/proton beam to induce a (d,*) or a (p,*) reaction to characterize the atomic compositions of industrial materials addressing the aforementioned needs and problems is desired.

### SUMMARY OF INVENTION

Embodiments include apparatuses, systems and methods related to the use of a proton/deuteron cyclotron for materials analysis in various industrial applications. Exemplary embodiments of methods include the steps of positioning a target material for irradiation on a sample holder, focusing a negative hydrogen ion beam or negative deuteron ion beam from the cyclotron to the target material; irradiating the target material to induce (d,*) or (p,*) reactions with the target material thereby resulting in a radiation emission, and detecting the radiation emission using a detector, wherein the hydrogen ion beam or the deuteron ion beam, such as a deuteron particle beam, produced by the cyclotron has an energy in a range of from and including 1 MeV to 3 MeV and desirably has a beam current in a range of from and including 5 pico-Amperes (pA) to 100 nano-Amperes (nA). However the beam current, while desirably within this range of beam current, can have a value or amount of beam current as can depend on the use or application, and should not be construed in a limiting sense. The beam current may be varied depending on the particular material for analysis, as well as the amount or value of the beam current can depend on the particular use or application, and should not be construed in a limiting sense. The methods can further include analyzing the emission from the target material using particle induced X-ray or gamma ray emission spectrum or Rutherford backscattering spectrum, for example.

Embodiments of apparatuses related to the embodiments of methods for using a proton/deuteron cyclotron for materials analysis and other industrial applications include a cyclotron configured to provide a particle beam line of hydrogen ion or deuteron ion irradiation to a target material, wherein the particle beam line produced by the cyclotron has an energy in a range of from and including 1 MeV to 3 MeV, a sample holder to hold a target material for analysis, a detector system including a detector having a standard reliable detection geometry, the detector system being configured to vary the detection geometry, a computer controller configured to control the cyclotron to generate and deliver the hydrogen ion or deuteron ion particle beam line for the irradiation; wherein the particle beam line induces a (d,*) or a (p,*) reaction with the target material thereby resulting in a radiation emission for detection by the detector.

The beam current of the proton particle beam is desirably in a range of from and including 5 pA to 100 nA. The detector of the detector system can include a silicon diode detector, a lithium diode detector, a bismuth germanate (BGO) detector and a high purity germanium (HPGe) detector, for example. The sample holder is rotatably configured to vary the irradiation geometry of the samples in a range of from and including orthogonal to 0° relative to the beam line. The detector of the detector system may be placed at an angle in a range of from and including 90° to 180° relative to the particle beam line, for example.

These and other features of the present invention will become readily apparent upon further review of the following specification and drawings.

### DESCRIPTION OF THE DRAWINGS

FIG. 1 is a schematic illustration of an overview of an embodiment of a 1 MeV to 3 MeV cyclotron system, according to the present invention.

### Unless otherwise indicated, similar reference characters denote corresponding features consistently throughout the attached drawing.

### DETAILED DESCRIPTION

The present disclosure relates to a 1 MeV to 3 MeV cyclotron configured to provide a particle beam of hydrogen ions or deuteron ions to a target sample material for characterizing the atomic compositions of materials through or by inducing a (d,*) or a (p,*) reaction that in turn distinguishes the different atomic constituents by measuring the X-ray emission of the outgoing radiation, such as protons, from the target sample including measuring the Rutherford backscattering emission.

As described herein, embodiments of a comprehensive cyclotron apparatus and system for material studies includes an easy to operate proton or deuteron cyclotron, a beam delivery system, a target holder for holding a sample target, and a detector system. As to negative hydrogen ion cyclotrons, U.S. Pat. No. 5,139,731 to Hendry, incorporated herein by reference in its entirety, discloses negative hydrogen ion (proton) cyclotron wherein the H− is produced by H² gas stripping of ions and, U.S. Pat. No. 7,554,275 to Amaldi, incorporated by reference herein in its entirety, discloses a proton accelerator cyclotron. As to deuteron cyclotrons, U.S. Pat. No. 7,888,891 B2 to Lida et al., incorporated by reference herein in its entirety, discloses a compact cyclotron system with deuteron beam energy ranging from 3.5 MeV to 10 MeV and Erdman et al., “Compact 9 MeV Deuteron Cyclotron with Pulsed Beam” Proc. XVI Cycl. Conf., (2001), p. 383-386, incorporated by reference herein in its entirety, discloses a compact commercial 9 MeV deuteron cyclotron. As to charged particle accelerator systems, U.S. Pat. No. 8,659,243 to Morita et al. discloses an accelerating tube for the cyclotron. All these patents and literature articles are incorporated herein by reference in their entirety, and, for example, include features that can be adapted for use in the methods and apparatuses of the various embodiments described herein using the guidance of the instant disclosure.

Embodiments of methods disclosed herein relate to the use of a proton/deuteron cyclotron for materials analysis and other industrial applications and include the steps of positioning a target material for irradiation on a sample holder, focusing a negative hydrogen ion or negative deuteron ion beam from the cyclotron to the target material; irradiating the target material to induce a deuteron-proton or proton-proton reaction thereby producing a radiation emission, and detecting the radiation emission using a detector, wherein the hydrogen ion or deuteron ion beam, such as a deuteron particle beam, produced by the cyclotron has an energy in a range of from and including 1 MeV to 3 MeV and has a beam current in a range of from and including 5 pA to 100 nA. However the amount or value of the beam current, while desirably within this range of beam current, can depend on the use or application, and should not be construed in a limiting sense. The beam current may be varied depending on the particular material for analysis, as well as the amount or value of the beam current can depend on the particular use or application, and should not be construed in a limiting sense. Embodiments of methods can further include analyzing the emission from the target material using a particle induced X-ray emission technique or a Rutherford backscattering technique, for example.

Embodiments of apparatuses disclosed herein relate to the use of a proton/deuteron cyclotron for materials analysis and other industrial applications and can include a cyclotron configured to provide a particle beam of a negative hydrogen ion or a negative deuteron ion to a target material, wherein the particle beam produced by the cyclotron has an energy in a range of from and including 1 MeV to 3 MeV, a sample holder to hold a target material for analysis, a computer controller configured to control the cyclotron to generate and deliver the negative hydrogen ion or negative deuteron ion particle beam for the irradiation, wherein the particle beam induces a deuteron-proton or proton-proton reaction with the target material thereby resulting in a radiation emission. The beam current of the hydrogen ion or deuteron ion particle beam, such as a proton particle beam, desirably can be, for example, in a range of from and including 5 pA to 100 nA. However, an amount or value of the beam current, while desirably within this range of beam current, can depend on the use or application, and should not be construed in a limiting sense.

Also, as stated herein, in embodiments of the apparatuses and methods, the beam current may be varied depending on the particular material for analysis, as well as an amount or value of the beam current can depend on the particular use or application and, therefore, should not be construed in a limiting sense. A suitable beam current typically depends on the particular application, for example. Further, the particular material being analyzed typically can be used to determine if a lower intensity or a higher intensity are required. If it is a micro beam for instance, the power density can be too high if work is required on the higher end of the intensity range. The beam intensity is related to the fragility of the sample, its intrinsic value (can be a sample devoted for only testing purposes or a high value historical item) and to the nuclear technique used, for example.

In an embodiment, the apparatuses for material analysis may include a detector, which is desirably a silicon diode detector or a lithium diode detector, a bismuth germanate (BGO) detector and high purity germanium (HPGe) detector, for example, or other suitable detector, as can depend on the use or application and should not be construed in a limiting sense.

Desirably, the detector is placed or positioned at an angle in a range from and including 10° to 180° relative to the particle beam line. The target material may include samples from archeological, industrial (semiconductors, motor oil etc.), historical, environmental (air, water wastes), biological etc., or other suitable samples, and should not be construed in a limiting sense. In other embodiments, the samples can include a thin film of carbon composite material, doped semiconductor crystals, filters for air pollution, metals in motor oil and metals in cells, or other suitable samples, for example, and should not be construed in a limiting sense.

As used herein, the term “Rutherford backscattering spectrometry” (RBS) is an analytical technique used in materials science to determine the structure and composition of materials by measuring the backscattering of a beam of high energy ions, typically protons or alpha particles or deuterons impinging on a sample. Typically, the energy distribution and yield of the backscattered ions at a given angle is measured. Since the backscattering cross section for each element is known, it is possible to obtain a quantitative compositional depth profile from the RBS spectrum obtained, such as for films that are less than 1 μm thick. Detectors to measure backscattered energy are usually silicon surface barrier detectors having a very thin layer (100 nm) of P-type silicon on an N-type substrate forming a p-n junction, for example.

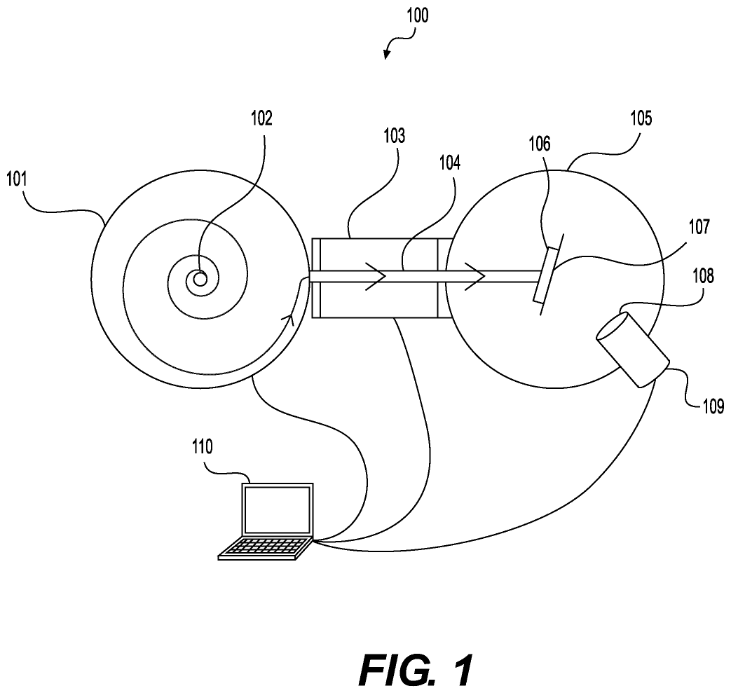

Referring now FIG. 1 in greater detail, an embodiment of an exemplary cyclotron system 100, such as a proton cyclotron system 100, such as for materials analysis in industrial settings is illustrated and has an energy in a range of from and including 1 MeV to 3 MeV and has a beam current in an range of from and including 5 pA to 100 nA, for example. The cyclotron system 100 includes a compact cyclotron 101, which also desirably has or is associated with an ionizing source 102 that can be a hydrogen gas or deuterium gas, for example. Further, the compact cyclotron 101 is associated with a beam line 103, such as a short extract beam line 103, to direct a deuteron/proton beam 104, such as a hydrogen ion beam or deuteron ion beam, such as a deuteron particle beam, from the compact cyclotron 101 to a target material sample 106 that is placed or positioned on a sample holder 107. The target material sample 106 is housed in a chamber 105, such as an enclosed chamber 105. It is to be understood that the length of the deuteron/proton beam 104 can be desirably shortened, such as by adjusting the distance of the target material sample 106 to the source of the deuteron/proton beam 104, the source being the compact cyclotron 101. The protons/deuterons are produced by and extracted from the compact cyclotron 101 and directed through the beam line 103, such as a tube beam line 103, towards or to the target material sample 106, which is to be analyzed by a detector system 109, such as including a detector 109, the detector 109 having a window 108 for receiving the transmission of the emitted radiation from the target material sample 106, for example. The analysis can also include analysis of samples that cannot be placed in a vacuum. The detector geometry, as well as the type of detector 109, the sample holder 107, and the target material sample 106, can be modified to change the detection geometry and the irradiation geometry, as can depend on the use or application, and should not be construed in a limiting sense.

Without wishing to be bound by theory, it is believed that the deuterons induce a reaction with the atomic materials of the target material sample 106 causing them to emit Electromagnetic radiation in the X-ray region. Additionally, without wishing to be bound by theory, it is believed that the irradiating proton and deuteron beam can also interact with the nucleus of the target material sample 106 through elastic collisions, so called Rutherford backscatttering, often repelling the proton/deuteron at angles close to 180° . The backscatter provides information about the thickness and composition of the target material sample 106. Thus, the X-ray, Gamma Ray emission and the Rutherford backscattered proton/deuteron is detected either in the forward or backward direction using the detector 109. The backscattering proton/deuteron and the X-ray characteristics are set by the materials that interact with the irradiation generated by the protons/deuterons.

In an embodiment, the detection technique can include Particle-induced X-ray Emission (PIXE). As can be appreciated by a person skilled in the art, PIXE is a technique used in analyzing the elemental make-up of a material or sample. Without being bound by theory, it is believed that when a material is exposed to an ion beam, atomic interactions occur that give off electromagnetic (EM) radiation of wavelengths in the X-ray part of the electromagnetic spectrum specific to an element. Thus, PIXE is a powerful yet non-destructive elemental analysis technique to analyze the materials as can be applied according to the present invention.

Exemplary PIXE technology as can be utilized, as modified by the guidance of the instant disclosure, can include, for example, the research article to Keizo Ishii, “PIXE and Its Applications to Elemental Analysis”, Quantum Beam Sic., 2019, 3, 1-14, which is incorporated herein by reference in its entirety, and discloses a PIXE imaging apparatus and a silicon detector, as well as a method for analyzing the characteristic X-rays emitted by the elements, such as sodium and uranium, contained in a sample. Due to the high signal to background ratio, PIXE is a very sensitive, nondestructive technique as can be used for a wide range of measured elements, with detection limits close to 1 ppm. The deuterons and protons can also interact with the nucleus of the atoms in the material or sample through elastic collisions and, by measuring the energy and intensity of the Rutherford backscattered beam of high energy protons, allows the determination of the composition and depth profile of elements on the target sample surface and below, such as the composition and depth profile of elements on the surface of and below the surface of the target material sample 106.

In embodiments, the detection technique can also include Particle-induced gamma-ray emission (PIGE). PIGE is a technique used in several fields to determine the elemental composition of a given sample or material, such as a sample of a given material. A high energy ion could go closer to a nucleus if its energy is higher than what is called a coulomb barrier of the nuclei. This can happen easier for low Z atoms (because they have less protons in the nucleus). When an ion gets close to a nucleus, it is able to excite the nucleus which may return it to be in a stable state by emitting photons in the gamma spectrum. PIGE and PIXE are typically used together because of their intrinsic complementarity (as reported in G. Demortier and F. Bodart “Complementarity of PIXE and PIGE for the characterization of gold items of ancient jewelry”, Journal of Radioanalytical Chemistry, Vol 69, No. 1-2 (1982) 239-257, incorporated herein by reference herein in its entirety.

Thus, in various embodiments, elemental concentration analysis of various industrial compounds is contemplated by the methods and apparatuses of the present invention.

Exemplary technology that may be utilized, as modified by the guidance of the instant disclosure, may include, for example, U.S. Pat. No. 7,888,891 to Lida et al., incorporated herein by reference in its entirety, which discloses particle beam accelerators (cyclotron). Also, such exemplary technology may include, for example, Erdman et al., “Compact 9 MeV Deuteron Cyclotron with Pulsed Beam” Proc. XVI Cycl. Conf., (2001), p. 383-386, incorporated herein by reference in its entirety, which discloses a compact deuteron cyclotron with D− ion source having a beam line. Exemplary nuclear reaction analysis using Rutherford backscattering spectroscopy can include the research article by Lanford et al., “Nuclear Reaction Analysis For H, Li, Be, B, C, N, O and F With An RBS check”, Nuclear Instruments and Methods in Physics Research B 371 (2016) 211-215, incorporated herein by reference in its entirety, which discloses nuclear reaction analysis for H, Li, Be, B, C, N, O and F with a 1.2 MeV deuteron beam using NRA (nuclear reaction analysis) spectroscopy and a silicon detector located or positioned at a 170° angle relative to the beam line and/or a bismuth germanate (BGO) detector located behind the sample. RBS is more sensitive to the high Z element, and the low Z element has been measured by NRA. NRA is another technique that the present inventors propose using with the apparatuses and methods herein described.

A computer controller 110 is used to control the cyclotron system 100 and to control the deuteron/proton beam and the beam intensity to accurately and precisely deliver protons to the target material, such as to the target material sample 106. The computer controller 110 desirably is a single control system for controlling the plurality of the components of the cyclotron system 100, such as to control the deuteron/proton beam intensity, and to control the detector system 109 including the detector 109 to analyze the emission spectrum and the Rutherford backscattered spectrum. Further, display elements of a display system in the computer controller 110 can include any of various suitable display elements or displays known in the art and are desirably controlled via a main controller in the computer controller 110. Displays, such as display screens, are typically provided to one or more operators. In an embodiment, for example, the computer controller 110 accurately calculates the delivery of the proton/deuteron beam 104, or other suitable radiation source, so as to be delivered in an optimal manner to the target material 106. In embodiments, the cyclotron system 100, such as for generating and delivery of the deuteron/proton beam 104, or other suitable radiation source systems for generating and delivery of other suitable radiation beams, including the detector 109 can be automated or semi-automated, for example.

The computer controller 110 controls operations of the cyclotron system 100, such as controlling the generation and delivery of the deuteron/proton beam 104, with input from the control panel, such as the keys on the computer controller 110. The computer controller 110 may represent, for example, a stand-alone computer, computer terminal, portable computing device, networked computer or computer terminal, or networked portable device. Data, programs or instructions for the generation and delivery of the deuteron/proton beam 104, or other suitable radiation beam, using the radiation delivery system may be entered into the computer controller 110 by the user via any suitable type of user interface, such as the control panel or computer keys, and may be stored in a computer readable memory in or associated with the computer controller 110, which may be any suitable type of computer readable and programmable memory. Calculations and control of the radiation delivery system, such as the cyclotron system 100, such as to control the generation and delivery of the deuteron/proton beam 104, for example, for delivery of the radiation to the target, such as the target material sample 106, are performed by a controller/processor of or associated with the computer controller 110. It is to be understood that the controller/processor may be any suitable type of computer processor. Further, calculations and other data or operations may be displayed to the user on a display of or associated with the computer controller 110, which may be any suitable type of computer display, such as a liquid crystal display (LCD) or a light emitting diode (LED) display, for example. Though not shown, another display can be connected to computer controller 110 to provide or show desired information related to the treatment, treatment process, and the like, for example.

The controller/processor in, of or associated with the computer controller 110 may be associated with, or incorporated into, any suitable type of computing device, for example, a personal computer or a programmable logic controller (PLC) or an application specific integrated circuit (ASIC), any of which can constitute the computer controller 110, for example. The display of the computer controller 110, the controller/processor of or associated with the computer controller 110, the memory in or associated with the computer controller 110, and any associated computer readable media are in communication with one another by any suitable type of data bus or by wireless communication, as is well known in the art. In this manner, the computer controller 110 is in communication with the cyclotron system 100, such as the proton particle beam system 100, for delivery and control of the treatment, for example.

Examples of computer readable media in or associated with the computer controller 110 include a magnetic recording apparatus, non-transitory computer readable storage memory, an optical disk, a magneto-optical disk, and/or a semiconductor memory (for example, RAM, ROM, etc.). Examples of magnetic recording apparatus that may be used in addition to the memory in or associated with the computer controller 110, or in place of such memory, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Advantageously, the reactions that deliver a deuteron/proton beam, such as the deuteron/proton beam 104, are typically operationally practical at relatively low energies in a range of from and including 1 MeV to 3 MeV and the cyclotron, such as the compact cyclotron 100, is much more compact as compared to those generally known in the art. Additionally, the cyclotron apparatus of the present invention is desirably cost effective for conducting routine industrial material analysis.

It is to be understood that the embodiments of the methods, apparatuses and systems taught and described in terms of a proton/deuteron beam are not intended to be limited to that of a proton/deuteron beam and are illustrative of and are applicable to of any of various suitable charged particle beam systems, as can depend on the use or application, and should not be construed in a limiting sense.

It is to be understood that the present invention is not limited to the embodiments described above but encompasses any and all embodiments within the scope of the following claims.

We claim:

1. A method of using a cyclotron for material analysis, comprising the steps of:
positioning a target material for irradiation on a sample holder;
focusing a beam comprising a hydrogen ion beam or a deuteron ion beam from a cyclotron for delivery to the target material;
irradiating the target material with the beam to induce a (d,*) or a (p,*) reaction with the target material to provide a radiation emission from the target material; and
detecting the radiation emission from the target material using a detector,
wherein the beam comprising the hydrogen ion beam or the deuteron ion beam produced by the cyclotron has an energy in a range of from and including 1 MeV to 3 MeV and has a beam current in a range of from and including 5 pA to 100 nA.

2. The method of using a cyclotron for material analysis according to claim 1, wherein the beam comprises a deuteron particle beam.

3. The method of using a cyclotron for material analysis according to claim 1, further comprising the step of: analyzing the radiation emission from the target material using one or more of a particle induced X-ray technique and a gamma ray emission technique.

4. The method of using a cyclotron for material analysis according to claim 1, wherein the target material is selected from the group consisting of a thin film of carbon composite material, doped semiconductor crystals, filters for air pollution, metals in motor oil and metals in cells.

5. The method of using a cyclotron for material analysis according to claim 1, wherein the detector is selected from the group consisting of a silicon diode detector, a lithium diode detector, a bismuth germanate (BGO) detector and high purity germanium (HPGe) detector.

6. The method of using a cyclotron for material analysis according to claim 1, wherein the radiation emission is proton or deuteron backscattering and wherein the proton or deuteron backscattering is analyzed using a Rutherford backscattering technique.

7. An apparatus for material analysis, comprising:
a cyclotron configured to provide a particle beam line of hydrogen ions or deuteron ions for irradiation of a target material, wherein the particle beam line produced by the cyclotron has an energy in a range of from and including 1 MeV to 3 MeV;
a sample holder configured to hold the target material for analysis;
a detector system including a detector, the detector being configured to detect a radiation emission from the target material from irradiating the target material with the particle beam line of the hydrogen ions or the deuteron ions; and
a computer controller configured to control the cyclotron to generate and deliver the particle beam line for irradiating the target material,
wherein the particle beam line induces a (d,*) or a (p,*) reaction with the target material to provide the radiation emission.

8. The apparatus for material analysis according to claim 7, wherein a beam current of the particle beam line of the hydrogen ions or the deuteron ions is in a range of from and including 5 pA to 100 nA.

9. The apparatus for material analysis according to claim 7, wherein an irradiation geometry of the target material is varied in a range of from and including orthogonal to 0° relative to the particle beam line.

10. The apparatus for material analysis according to claim 7, wherein the detector is selected from the group consisting of a silicon diode detector, a lithium diode detector, a bismuth germanate (BGO) detector and a high purity germanium (HPGe) detector.

11. The apparatus for material analysis according to claim 7, wherein the detector is placed at an angle between and including 90° to 180° relative to the particle beam line.
